(19) United States
(12) Patent Application Publication
(10) Pub. No.: US 2020/0242467 A1
(43) Pub. Date: Jul. 30, 2020

(54) CALCULATION METHOD AND CALCULATION DEVICE FOR SPARSE NEURAL NETWORK, ELECTRONIC DEVICE, COMPUTER READABLE STORAGE MEDIUM, AND COMPUTER PROGRAM PRODUCT

(71) Applicant: SHENZHEN INTELLIFUSION TECHNOLOGIES CO., LTD., SHENZHEN (CN)

(72) Inventors: QINGXIN CAO, SHENZHEN (CN); LEA HWANG LEE, SHENZHEN (CN); WEI LI, SHENZHEN (CN)

(21) Appl. No.: 16/627,293

(22) PCT Filed: Mar. 16, 2018
(86) PCT No.: PCT/CN2018/079373

§ 371 Date: Dec. 29, 2019

(30) Foreign Application Priority Data
Dec. 29, 2017 (CN) 201711480629.0

(51) Int. Cl. G06N 3/08; G06N 20/10; G06K 9/62

(52) U.S. Cl. CPC G06N 3/08; G06K 9/6249; G06N 20/10

(57) ABSTRACT

A calculation method includes: receiving a calculation instruction of a parse neural network, obtaining a weight CO*CI*n*m corresponding to the calculation instruction according to the calculation instruction; determining a KERNEL SIZE of the weight, scanning the weight with the KERNEL SIZE as a basic granularity to obtain a weight identifier, storing KERNEL corresponding to a second feature value of the weight identifier, deleting KERNEL corresponding to a first feature value of the weight identifier; scanning all values of the weight identifier; if the value is equal to a second specific value, extracting KERNEL and input data corresponding to the value, performing computation of the input data and the KERNEL to obtain an initial result; if the value is equal to the first feature value, not reading KERNEL and input data corresponding to the value; performing computation of all the initial results to obtain a calculation result of the calculation instruction.

### CROSS-REFERENCE TO RELATED APPLICATIONS

This application claims the benefit of priority from Chinese Patent Application NO. 201711480629.0 entitled “CALCULATION METHOD FOR SPARSE NEURAL NETWORK AND RELATED PRODUCTS” and filed on Dec. 29, 2017, the content of which is hereby incorporated in its entire by reference.

### FIELD

The present disclosure relates to the field of artificial intelligence (AI) technology, and more particularly, to a calculation method and a calculation device for a sparse neural network, an electronic device, a computer readable storage medium and a computer program product.

### BACKGROUND

With the increasing maturity of artificial intelligence (AI) technology, application scenarios and product demands of all walks of life show explosive growth. In order to meet the needs of commercial products, computational complexity of artificial intelligence neural network algorithm will be very huge, which thereby requires high cost and huge power consumption for hardware. For a large number of embedded devices and terminal devices, too much computation and huge power consumption is a very big challenge or choke point. Therefore, algorithms with smaller and faster neural network models are urgently needed in the industry, and neural network sparsification is an important optimization direction and research branch of current algorithms.

However, calculations for sparse neural network in the existing technology are relatively more complicated in implementation, and it is difficult to make full use of computing resources. Therefore, the existing sparse neural network has a large amount of computation and high power consumption.

### SUMMARY

Embodiments of the present disclosure provide a calculation method and a calculation device for a sparse neural network, an electronic device, a computer readable storage medium and a computer program product, which can reduce the amount of computation of the sparse neural network, thereby having the advantages of reducing power consumption and saving calculation time.

A first aspect, one embodiment of the present disclosure provides a calculation method for a sparse neural network, the calculation method includes the following steps:

receiving a calculation instruction of a sparse neural network, and obtaining a weight CO*CI*n*m corresponding to the calculation instruction, according to the calculation instruction; determining a kernel size KERNEL SIZE of the weight, and scanning the weight with the kernel size as a basic granularity to obtain a weight identifier, wherein, the weight identifier includes: CO*CI values, if all weights in a k-th basic granularity KERNELₖ are 0, a weight identifier [K] corresponding the k-th basic granularity KERNELₖ in a corresponding position of the weight identifier is marked as a first feature value; if weights in the k-th basic granularity KERNELₖ are not all 0, the weight identifier [K] corresponding the k-th basic granularity KERNELₖ in a corresponding position of the weight identifier is marked as a second feature value; wherein, a range of k is [1, CO*CI]; storing KERNEL[n] [m] corresponding to the second feature value of the weight identifier, and deleting KERNEL[n] [m] corresponding to the first feature value of the weight identifier;

scanning all values of the weight identifier, extracting KERNEL corresponding to the values of the weight identifier and input data corresponding to the KERNEL and performing computation of the input data and the KERNEL to obtain an initial result when the values of the weight identifier are equal to the second feature value, and not reading the input data and the KERNEL corresponding to the values of the weight identifier when the values of the weight identifier are equal to the first feature value;

performing computation of all the initial results to obtain a calculation result of the calculation instruction.

Optional, the n and m are integers greater than or equal to 1.

Optional, the step of storing KERNEL[n] [m] corresponding to the second feature value of the weight identifier, includes:

scanning a kernel identifier; obtaining a value corresponding to a position of the kernel identifier; and, storing a KERNEL value corresponding to the position where the weight identifier is equal to 1 and the kernel identifier is equal to 1.

Optional, when n=3 and m=3, the step of performing computation of the input data and the KERNEL to obtain an initial result, includes:

scanning all values of a kernel identifier corresponding to KERNEL[3] [3], wherein the kernel identifier includes 9 bits corresponding to 9 elements of the KERNEL[3] [3]; if a value of a position x2 of the kernel identifier is equal to 0, not reading an element value of the KERNEL[3][3] corresponding to the position x2; if a value of a position x1 of the kernel identifier is equal to 1, determining the position x1 corresponding to the value, and reading an element value KERNEL[3][3]ₓ₁ corresponding to the position x1 of the KERNEL [3] [3] and input data x1 corresponding to the position x1; performing a product operation of the element value KERNEL[3] [3]ₓ₁ and the input data x1 to obtain a product result; wherein, a value range of x1 is [1, 9]; and obtaining the initial result by summing up all the product results with a value of the kernel identifier equal to 1.

A second aspect, one embodiment of the present disclosure provides a calculation device for a sparse neural network, and the calculation device includes:

a transceiver interface, configured to receive a calculation instruction of a sparse neural network;

an obtaining circuit, configured to obtain a weight CO*CI*n*m corresponding to the calculation instruction from a memory, according to the calculation instruction;

a compiling circuit, configured to determine a kernel size KERNEL SIZE of the weight and scan the weight with the kernel size KERNEL SIZE as a basic granularity to obtain a weight identifier; wherein, the weight identifier includes: CO*CI values, if all weights in a k-th basic granularity KERNEL_{K} are 0, a weight identifier [K] corresponding the k-th basic granularity KERNEL_{K} in a corresponding position of the weight identifier is marked as a first feature value; if weights in the k-th basic granularity KERNEL_{K} are not all 0, the weight identifier [K] corresponding the k-th basic granularity KERNEL_{K} in a corresponding position of the weight identifier is marked as a second feature value; wherein, a range of k is [1, CO*CI]; the compiling circuit, further configured to store KERNEL [n] [m] corresponding to a second feature value of the weight identifier and delete KERNEL [n] [m] corresponding to a first feature value of the weight identifier;

a calculation circuit, configured to scan all values of the weight identifier, extract KERNEL corresponding to the values of the weight identifier and input data corresponding to the KERNEL and perform computation of the input data and the KERNEL to obtain an initial result when the values of the weight identifier are equal to the second feature value, and not reading the KERNEL corresponding to the values and the input data corresponding to the KERNEL when the values of the weight identifier are equal to the first feature value; the calculation circuit, further configured to perform computation of all the initial results to obtain a calculation result of the calculation instruction.

Optional, the n and m are integers greater than or equal to 1.

Optional, the first feature value is 0, and the second feature value is 1; or, the first feature value is 1, and the second feature value is 0.

Optional, when n=3 and m=3, the calculation circuit is specifically configured to scan all values of a kernel identifier corresponding to KERNEL [3] [3], wherein the kernel identifier includes 9 bits corresponding to 9 elements of the KERNEL [3] [3]; the calculation circuit is configured to, if a value of a position x2 of the kernel identifier is equal to 0, not read an element value of the KERNEL [3] [3] corresponding to the position x2; the calculation circuit is configured to, if a value of a position x1 of the kernel identifier is equal to 1, determine the position x1 corresponding to the value, and read an element value KERNEL[3] [3]ₓ₁ corresponding to the position x1 of the KERNEL [3] [3] and input data x1 corresponding to the position x1; the calculation circuit is further configured to perform a product operation of the element value KERNEL[3] [3]ₓ₁ and the input data x1 to obtain a product result; wherein, a value range of x1 is [1, 9]; and, the calculation circuit is further configured to obtain the initial result by summing up all the product results with a value of the kernel identifier equal to 1.

A third aspect, one embodiment of the present disclosure provides an electronic device, and the electronic device includes the calculation device for a sparse neural network provided in the second aspect.

A fourth aspect, one embodiment of the present disclosure provides a computer readable storage medium, on which computer programs are stored for electronic data interchange, the computer programs enable a computer to perform the calculation method provided in the first aspect.

A fifth aspect, one embodiment of the present disclosure provides a computer program product, including a non-transient computer readable storage medium in which computer programs are stored, and the computer programs enable a computer to perform the calculation method provided in the first aspect.

Embodiments of the present disclosure have the following beneficial effects:

as can be seen from the above technical solution, in order to compress weight parameters, the present disclosure increases the weight identifier and the kernel identifier. For the sparse network model, there are more weight elements whose values are 0, so weight parameter space can be saved, and saved weight parameter space is much larger than increased weight identifiers and kernel identifier information. In addition, compressed parameters can effectively save storage space and the bandwidth of DDR memory. As shown in FIG. 3 of the technical solution provided in the embodiment, when the weight identifier is zero, it does not extract corresponding input data, which can save the overhead of data transmission between a calculator and a memory and remove corresponding operations, thereby reducing the amount of computation, reducing power consumption and saving cost.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the disclosure, for persons of ordinary skills in this field, other drawings can be obtained according to the drawings below on the premise of no creative work.

FIG. 1 is a block diagram of an electronic device provided in one embodiment of the present disclosure.

FIG. 2 is a schematic diagram of data operation of a sparse neural network provided in one embodiment of the present disclosure.

FIG. 3 is a flowchart of a calculation method for a sparse neural network provided in one embodiment of the present disclosure.

FIG. 3a is a schematic diagram of a weight identifier provided in one embodiment of the present disclosure.

FIG. 3b is a schematic diagram of KERNEL [3] [3] provided in one embodiment of the present disclosure.

FIG. 3c is a schematic diagram of KERNEL [3] [3] provided in another embodiment of the present disclosure.

FIG. 3d is a schematic diagram of a kernel identifier provided in one embodiment of the present disclosure.

FIG. 4 is a block diagram of a chip provided in one embodiment of the present disclosure.

FIG. 5 is a block diagram of a calculation device for a sparse neural network provided in one embodiment of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. Based on the embodiments of the disclosure, all other embodiments obtained by persons of ordinary skills in this field without creative work shall fall within the protection scope of the present disclosure.

An electronic device described in the embodiments of the disclosure may include: a server, a smart camera, a smart phone (such as an Android phone, a iOS phone, a Windows Phone, etc.), a tablet computer, a handheld computer, a laptop, a mobile internet device (MID) or a wearable device, etc., which is only an example, not exhaustive, and is not limited the electronic device listed above. For the sake of description, the electronic device mentioned above is referred to as a User equipment (UE), a terminal or an electronic apparatus in the following embodiments. Of course, in practical applications, the above-mentioned electronic device is not limited to the above realization forms. For example, it can also include: an intelligent vehicle-mounted terminal, a computer equipment, and so on.

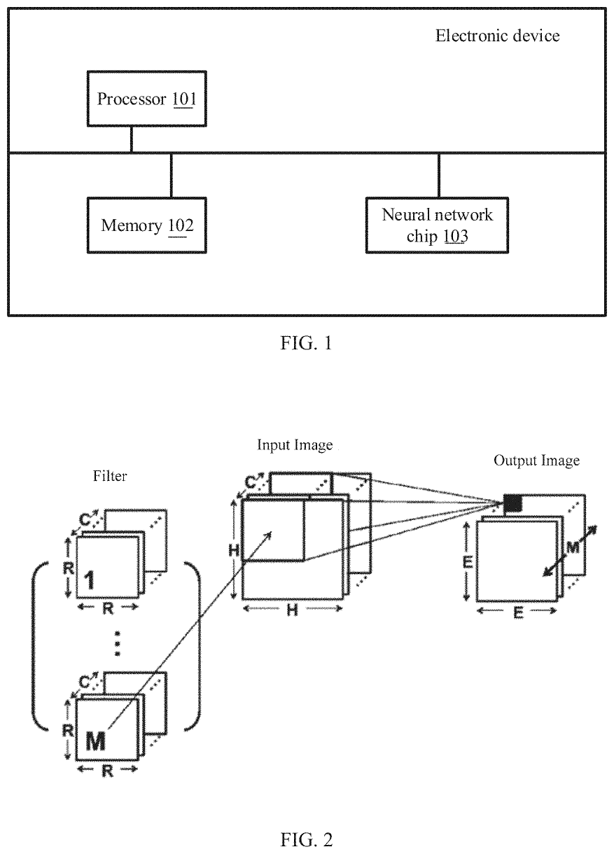

For the electronic device mentioned above, its structure is shown in FIG. 1, which illustrates a block diagram of an electronic device provided in one embodiment of the present disclosure. In detail, the electronic device can include: a processor 101, a memory 102, and a neural network chip 103, and the processor 101 is connected to the memory 102 and the neural network chip 103.

Specifically, in an optional technical solution, the neural network chip 103 can be integrated into the processor 101. The memory 102 can include: a flash disk, a Read-Only Memory (ROM), a Random Access Memory (RAM), etc. The technical solution of the disclosure will not be limited whether the neural network chip 103 is set up separately or integrated in the processor 101. That is, the neural network chip 103 can be set up separately, or be integrated into the processor 101, or be set up in other ways, which is not limited in this technical solution of the present disclosure.

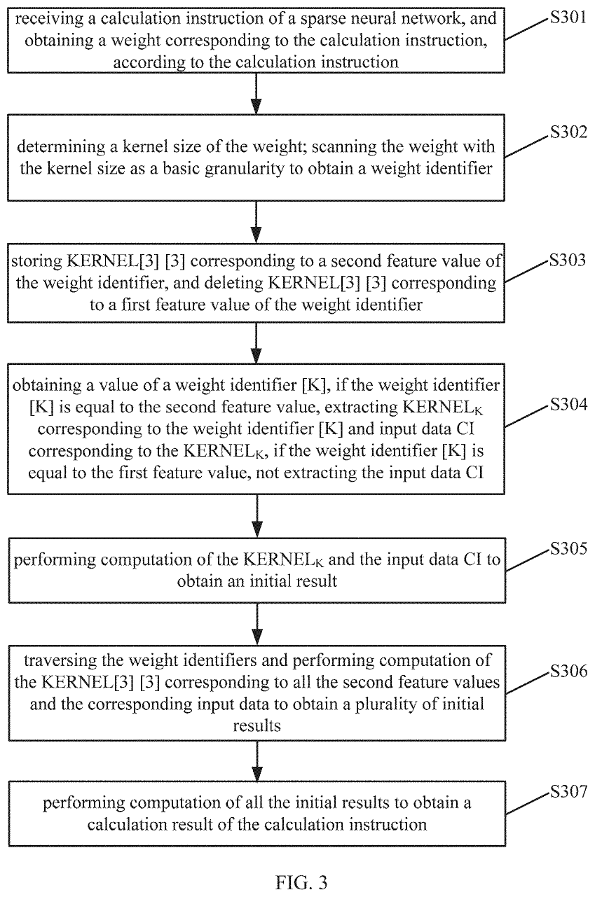

FIG. 2 illustrates a schematic diagram of data operation of a sparse neural network provided in one embodiment of the present disclosure. As shown in FIG. 2, values of WEIGHTS of each neural network model can also be referred to as weights, and the weights basically determine a computational complexity of the neural network model. Optimization of sparsification is to optimize more elements in the WEIGHTS into 0 as much as possible on the premise of not changing the structure of the neural network model, so as to greatly reduce the computation complexity of the neural network model. Inputs of the neural network model includes two channels, one is the WEIGHTS (such as Filter shown in FIG. 2), the other is Input Image (CI). One output of the neural network model is Output Image (CO).

In one embodiment, the neural network model can include many layers of calculations. Each layer of calculation may include, such as, a matrix multiplication by matrix operation, a convolution operation, and other complex operations. For a neural network model after sparsification, namely, for a neural network model after sparse processing, it can also be called a sparse neural network model or a sparse neural network. Compared with the neural network, the sparse neural network has the characteristic of a large number of elements whose value is 0 in the weight. Since the number of elements whose value is 0 in the weight is relatively large, and the calculation amount is relatively small, so the neural network model after sparsification (namely, the neural network model after sparse processing) is called a sparse neural network. As shown in FIG. 2, the schematic diagram in FIG. 2 illustrates a representation of a weight of the sparse neural network.

A calculation solution of the neural network model is introduced in the following contents. In detail, the calculation solution can be divided into several layers of calculations, and each layer of calculation is an operation between the input data and the weights of this layer, namely, an operation between the Input Image and the Filter of this layer as shown in FIG. 2. The operation may include, but not limited to: a convolution operation, a matrix multiplication by matrix operation, and so on. The schematic diagram shown in FIG. 2 can be a convolution operation at a certain layer of the neural network model, specifically:

the Filters represent the weights in the neural network model;

the Input Image represents the input data (CI) of the present disclosure;

the Output Image represents the output data (CO) of the present disclosure;

each CO can be obtained by adding all products of each input data (CI) being multiplied by a corresponding weight.

The number of weights is CI NUM*CO NUM, and each weight is a two-dimensional matrix data structure.

For the calculation solution as shown in FIG. 2, although the neural network model after sparsification (i.e., the sparse neural network model or the sparse neural network) can reduce a certain degree of data computation, but its process mode does not optimize the sparse calculation, compared with the neural network, the amount of calculation is not much reduced. In fact, the power consumption of the neural network chip is directly related to the amount of calculation of the neural network model, so that the calculation method mentioned above cannot reduce the power consumption of the neural network chip.

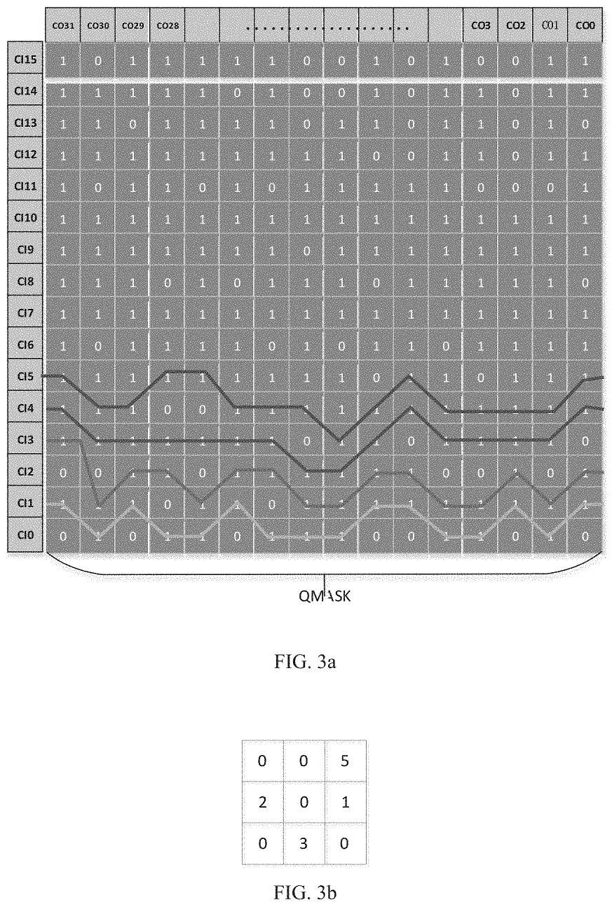

FIG. 3 illustrates a flowchart of a calculation method for sparse neural network provided in one embodiment of the present disclosure, which can be executed by a processor or a neural network processing chip. As shown in FIG. 3, the calculation method for a sparse neural network at least includes the following steps.

step S301, receiving a calculation instruction of a sparse neural network, and obtaining a weight CO*CI*n*m corresponding to the calculation instruction, according to the calculation instruction.

step S302, determining a kernel size KERNEL SIZE[n] [m] of the weight, and scanning the weight with the kernel size as a basic granularity to obtain a weight identifier; the weight identifier includes: CO*CI values, if all weights (namely, the element values) in a k-th basic granularity KERNELₖ are 0, a weight identifier QMASK [K] corresponding the k-th basic granularity KERNELₖ in a corresponding position of the weight identifier is marked as a first feature value (such as 0); if weights (namely, the element values) in the k-th basic granularity KERNELₖ are not all 0, the weight identifier [K] corresponding the k-th basic granularity KERNELₖ in a corresponding position of the weight identifier is marked as a second feature value (such as 1); wherein, a range of k is [1, CO*CI].

FIG. 3a illustrates a schematic diagram of a weight identifier provided in one embodiment of the present disclosure. As shown in FIG. 3a, CI NUM=16, and CO NUM=32. Specifically, when k=1, as shown in FIG. 3a, its value is 1, indicating that there is at least one none-zero weight in the weights of KERNEL [3] [3].

Optional, n=1, 3 or 5. Taking n=3 as an example, such as KERNEL [3] [3], as shown in FIG. 3b, there are four non-zero weights. FIG. 3b is a schematic diagram of KERNEL [3] [3] provided in one embodiment of the present disclosure.

For example, when the weight identifier [1]=1, a kernel identifier (WMASK) [1] is generated. The kernel identifier [1] includes n*m bits, and each bit indicates whether a corresponding element value in KERNEL [3] [3] is zero or not. KERNEL [3] [3] as shown in FIG. 3b, and a kernel identifier [1] corresponding to the KERNEL [3] [3] is shown in FIG. 3d. That is, the kernel identifier [1] corresponding to the KERNEL [3] [3] in FIG. 3b is shown in FIG. 3d. FIG. 3d is a schematic diagram of a kernel identifier provided in one embodiment of the present disclosure.

As shown in FIG. 3a, when k=2, its value is 0, that is, all weights of KERNEL [3] [3] are zero. As shown in FIG. 3c, all the weights are zero. FIG. 3c is a schematic diagram of KERNEL [3] [3] provided in another embodiment of the present disclosure.

step S303, storing KERNEL[3] [3] corresponding to the second feature value of the weight identifier, and deleting KERNEL[3] [3] corresponding to the first feature value of the weight identifier.

The specific way to implement the step S303 can be: when KERNEL[n][m] corresponding to the second feature value of the weight identifier is stored, the whole KERNEL[n][m] is not stored, but combined with the kernel identifier, only a KERNEL value corresponding to the position where QASM=1 & KERNEL identifier=1 is stored.

For the weight identifier which is a coarse-grained identifier, it indicates that the KERNEL [n][n] are all 0; for the kernel identifier which is a fine-grained identifier, it indicates which element is zero, and which element is non-zero inside the KERNEL [n][n]. In this way, the weight identifier combined with the kernel identifier can represent all the zeros in the weights, that is, the combination of the weight identifier and the kernel identifier can represent all the zeros in the weights, which can instruct a control device to skip and omit the calculation performed on weights whose value is 0 in all the weights, thus reducing the power consumption and the amount of calculation.

The weight identifier and the kernel identifier are processed offline, and can be obtained by offline scanning. The weights can be compressed according to the weight identifier and the kernel identifier (that is, zero-valued elements are deleted, only non-zero elements are stored, and positions of the non-zero elements are indicated by the combination of the weight identifier and the kernel identifier).

step S304, obtaining a value of the weight identifier [K], extracting KERNEL_{K} corresponding to the weight identifier [K] and input data CI corresponding to the KERNEL_{K} when the weight identifier [K] is equal to the second feature value, and not extracting the input data CI when the weight identifier [K] is equal to the first feature value.

step S305, performing computation of the KERNEL_{K} and the input data CI to obtain an initial result.

The implementation method of the step S305 can include:

reading n*m bit values of the kernel identifier [k] corresponding to the KERNEL_{K}; traversing all the bit values of the kernel identifier [k]; performing computation of a weight with non-zero bit value and corresponding input data CI to obtain at least one preposition result; in detail, if the bit value is zero, computation corresponding to the bit value of zero is not performed; if the bit value is non-zero, a weight corresponding to the KERNEL_{K} of the bit value is read, the computation of the weight with non-zero bit value and corresponding input data CI is performed to obtain the preposition result; combining the at least one preposition result to obtain the initial result.

step S306, traversing the weight identifiers and performing computation of the KERNEL[3][3] corresponding to all the second feature values and the corresponding input data to obtain a plurality of initial results.

step S307, performing computation of all the initial results to obtain a calculation result of the calculation instruction.

As shown in FIG. 3 of the embodiment, in order to compress weight parameters and increase the weight identifier and the kernel identifier, for the sparse network model, there are more weight elements whose value is 0, so weight parameter space can be saved, and saved weight parameter space is much larger than increased weight identifiers and kernel identifier information, and compressed weight parameters can effectively save storage space and the bandwidth of DDR. As shown in FIG. 3 of the technical solution provided in the embodiment, when the weight identifier is zero, it does not extract corresponding input data, which can save the overhead of data transmission between a calculator and a memory and remove corresponding operations, thereby reducing the amount of computation. As shown in FIG. 3, input of the technical solution is the weight identifier, the kernel identifier and the weight (after compression). A decoding calculation is carried out according to a compression algorithm, the weight 0 in the weights can be directly skipped during the process of decoding to save power consumption and bandwidth, therefore improving performance, reducing power consumption and saving cost.

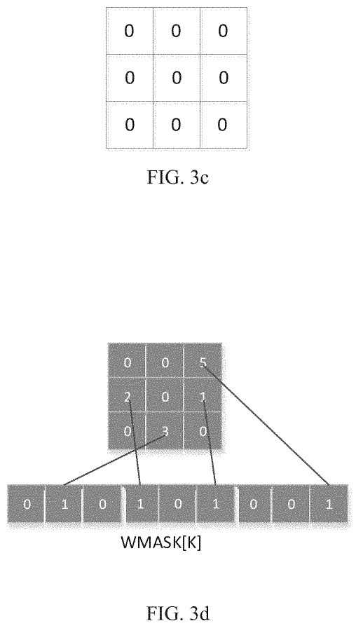

FIG. 4 illustrates a block diagram of a neural network processing chip provided in one embodiment of the present disclosure. As shown in FIG. 4, the neural network processing chip can be a neural network processor, which includes: a memory DDR, a data transmission circuit IDMA, a parameter transmission circuit WDMA, and a calculation processing circuit PE. Wherein,

the data transmission circuit IDMA is a data transmission circuit inside the neural network processor (mainly transmitting input data);

the parameter transmission circuit WDMA is a parameter transmission circuit inside the neural network processor (mainly transmitting the weight data and the weight identifier);

the data transmission circuit IDMA is configured to control transmission of CI data from the memory DDR to the calculation processing circuit PE according to information of the weight identifier. That is, the data transmission circuit IDMA is configured to control the CI data to be transmitted from the memory DDR to the calculation processing circuit PE according to the information of the weight identifier. In detail,

a value of a certain position marked by the weight identifier is equal to 0, which indicates that KERNEL n*m of CI->CO corresponding to this value of a certain position is all 0. Then, no matter what the value of CI is, a calculated result CO corresponding to this CI is identically equal to 0, algorithmically.

When the data transmission circuit IDMA obtains that the value of a certain position marked by the weight identifier is equal to 0, then the certain position is directly skipped to a next position of the weight identifier. That is, when the data transmission circuit IDMA obtains that the value of a certain position marked by the weight identifier is equal to 0, then the data transmission circuit IDMA skips the certain position directly to the next position of the weight identifier. If a value of the next position of the weight identifier is 1, then a non-zero CI position corresponding the next position of the weight identifier is transferred to the calculation processing circuit PE, which saves unnecessary data handling and internal storage, and saves power consumption and storage space the chip. Directly skipping to the non-zero position corresponding the next position of the weight identifier cooperated with the calculation of the calculation processing circuit PE can ensure timely data supply and improve calculation speed.

The parameter transmission circuit WDMA, is configured to transfer compressed weights and compressed kernel identifiers from the memory DDR to the calculation processing circuit PE.

All zeros have been removed from the weigh, and handling amount and power consumption of the parameter transmission circuit WDMA have been optimized to the maximum. Identifiers are sent to the calculation processing circuit PE, which is used to indicate the calculation processing circuit PE how to perform jump zero calculation and improve the calculation efficiency.

Calculation and Processing

The calculation processing circuit PE is a calculation processing circuit in the neural network processor;

the calculation processing circuit PE is configured to perform an accumulative calculation of sum of products between the CI and the weights:

the calculation processing circuit PE obtains products of CI and the weights, and sums the products, the products of all the CI and the weights are obtained by use of a general method, whether or not the weights are 0, and then all the products are added up to obtain a cumulative result.

However, for elements with a median weight of 0, the product is also 0, which has no effect on the cumulative result. If the elements with a median weight of 0 can be skipped directly, calculation efficiency can be greatly accelerated, and the amount of calculation and the power consumption can be reduced.

Since the weight identifiers and the kernel identifiers are added to identify positions and distributions of weight 0, the calculation processing circuit PE can directly skip the calculations performed on the elements whose value is 0 in the weights according to position information of the weight 0 identified by the weight identifiers and the kernel identifiers. In detail,

step a, scanning a weight identifier [1] by the calculation processing circuit, and determining a kernel identifier KERNEL [1] corresponding to the weight identifier [1] to be all zero and skipping the weight identifier [1] if the weight identifier [1]=0;

step b, scanning a weight identifier [1+1] and analyzing a kernel identifier KERNEL [1+1]corresponding to the weight identifier [1+1] if the weight identifier [1+1]=1 by the calculation processing circuit;

step c, analyzing a position x1 of a 1 in the kernel identifier KERNEL [1+1], reading data of CI[1+1]ₓ₁ in a cache BUF, extracting KERNEL[1+1]ₓ1 from corresponding values of the position x1 of the kernel identifier KERNEL [1+1], and performing a product operation of the KERNEL[1+1]ₓ₁ and the data of CI[1+1]ₓ₁ to obtain a product result;

moreover, the data of CI[1+1]ₓ₁ can be obtained according to the principle of operation. For example, if it is a convolution operation, the position of the data of CI[1+1]ₓ₁ in CI data and the specific value of CI[1+1]ₓ₁ can be determined according to the principle of convolution operation.

step d, repeating the step c until all values of the kernel identifier KERNEL [1+1] are analyzed by the calculation processing circuit;

step e, scanning a subsequent value of the weight identifier [1+1] and analyzing a kernel identifier KERNEL [k] corresponding to a weight identifier [k] if the weight identifier [k]=1 corresponding to the subsequent value;

step f, analyzing a position x1 of a 1 in the kernel identifier KERNEL [k], reading data of CI[k]ₓ₁ in a cache BUF, extracting KERNEL[k]ₓ₁ from corresponding values of the position x1 of the kernel identifier KERNEL [k], and performing a product operation of the KERNEL[k]ₓ₁ and the data of CI[1+1]ₓ₁ to obtain a product result;

step g, repeating the step f until all values of the kernel identifier KERNEL [k] are analyzed by the calculation processing circuit;

step h, traversing all values of the kernel identifier by the calculation processing circuit, executing the step a, when the values are zero; executing the steps e, f and g, when the values are 1;

step I, performing a product result operation on all the product results to obtain a calculation result by the calculation processing circuit, wherein, the product result operation includes, but not limited to: an activation operation, a sorting operation, an accumulation operation, a conversion operation, and so on.

Based on the above calculation principle, the calculation processing circuit of this disclosure can analyze two layers of data, namely the weight identifier and the kernel identifier, and then the calculation processing circuit can simply skip the calculations performed on the elements whose value is 0 according to values of the two layers of data, and then cooperate with compressed weights to complete model calculations efficiently. Since the structure of the chip as shown in FIG. 4 can directly skip the calculations performed on the elements whose value is all 0, so that the elements whose value is all 0 will not be stored.

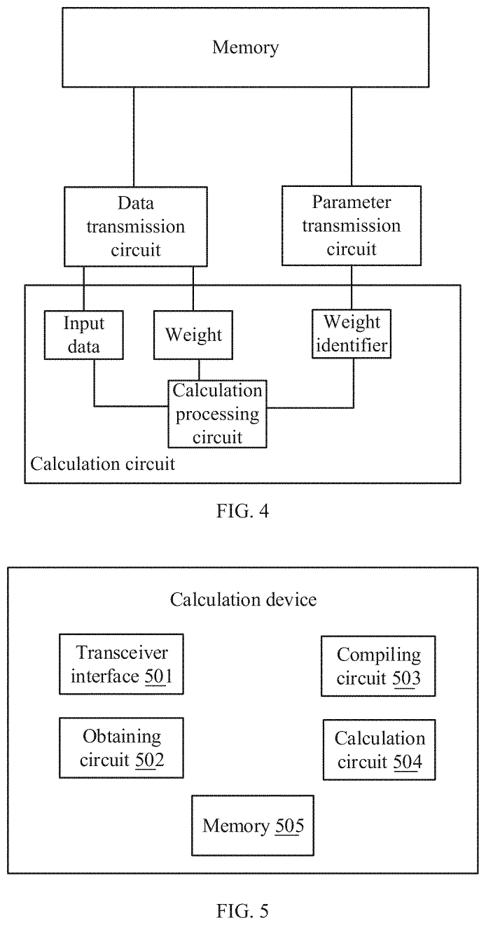

Please refer to FIG. 5, FIG. 5 illustrates a block diagram of a calculation device for a sparse neural network provided in one embodiment of the present disclosure. In this embodiment, the calculation device at least includes: a transceiver interface 501, an obtaining circuit 502, a compiling circuit 503, a calculation circuit 504, and a memory 505; wherein,

the transceiver interface 501, is configured to receive a calculation instruction of a sparse neural network,

the obtaining circuit 502, is configured to obtain a weight CO*CI*n*m corresponding to the calculation instruction from the memory 505, according to the calculation instruction;

the compiling circuit 503, is configured to determine a kernel size KERNEL SIZE of the weight and scan the weight with the kernel size KERNEL SIZE as a basic granularity to obtain a weight identifier; wherein, the weight identifier includes: CO*CI values, if all weights in a k-th basic granularity KERNEL_{K} are 0, a weight identifier [K] corresponding the k-th basic granularity KERNEL_{K} in a corresponding position of the weight identifier is marked as a first feature value (such as 0); if weights in the k-th basic granularity KERNEL_{K} are not all 0, the weight identifier [K] corresponding the k-th basic granularity KERNEL_{K} in a corresponding position of the weight identifier is marked as a second feature value (such as 1); wherein, a range of k is [1, CO*CI]; the compiling circuit 503 is further configured to store KERNEL [n] [m] corresponding to a second feature value of the weight identifier and delete KERNEL [n] [m] corresponding to a first feature value of the weight identifier;

the calculation circuit 504, is configured to scan all values of the weight identifier, and extract KERNEL corresponding to the values of the weight identifier and input data corresponding to the KERNEL and perform computation of the input data and the KERNEL to obtain an initial result when the values of the weight identifier are equal to the second feature value, and not read the KERNEL corresponding to the values and the input data corresponding to the KERNEL when the values of the weight identifier are equal to the first feature value; the calculation circuit 504 is further configured to perform computation of all the initial results to obtain a calculation result of the calculation instruction.

In one embodiment, the n is equal to any of values 1, 3, and 5.

In one embodiment, the first feature value is 0, and the second feature value is 1;

or, the first feature value is 1, and the second feature value is 0.

In one embodiment, when n=3, the calculation circuit 504 is specifically configured to scan all values of a kernel identifier corresponding to KERNEL [3] [3], the kernel identifier includes 9 bits corresponding to 9 elements of the KERNEL [3] [3]; the calculation circuit 504 is configured to, if a value of a position x2 of the kernel identifier is equal to 0, not read an element value of the KERNEL [3] [3] corresponding to the position x2; the calculation circuit 504 is configured to, if a value of a position x1 of the kernel identifier is equal to 1, determine the position x1 corresponding to the value, and read an element value KERNEL[3] [3]ₓ₁ of the position x1 of the KERNEL [3][3] and input data x1 corresponding to the position x1; the calculation circuit 504 is further configured to perform a product operation of the element value KERNEL[3] [3]ₓ₁ and the input data x1 to obtain a product result. Wherein, a value range of x1 is [1, 9]. The calculation circuit 504 is further configured to obtain the initial result by summing up all the product results with a value of the kernel identifier equal to 1.

Embodiments of the present disclosure further provide an electronic device including the calculation device for a sparse neural network mentioned above.

Embodiments of the present disclosure further provide a computer readable storage medium in which computer programs are stored for electronic data interchange, and the computer programs enable a computer to perform some or all steps of any of the calculation method for a sparse neural network as described in method embodiments mentioned above.

Embodiments of the present disclosure further provide a computer program product including a non-transient computer readable storage medium in which computer programs are stored, and the computer programs enable a computer to perform some or all steps of any of the calculation method for a sparse neural network as described in method embodiments mentioned above.

It should be noted that, for the method embodiments mentioned above, for a brief description, therefore, the method embodiments above are expressed as a series of action combinations, but a person having ordinary skills in the field should be aware that, this application is not limited by action sequences described above, because according to this application, some steps may be taken in other orders or simultaneously. Secondly, a person having ordinary skills in the field should also be aware that the embodiments described in the specification are optional embodiments and the actions and modules involved are not necessary for this application.

In the above embodiments, the description of each embodiment has its own emphasis, and parts not specified in one embodiment can be referred to the relevant description of other embodiments.

It should be understood that the disclosed apparatus in the embodiments provided by the present disclosure can be implemented in other ways. For example, the apparatus embodiments described above are merely schematic, for example, the division of the modules is merely a division of logical functions, which can also be realized in other ways; for example, multiple units or components can combined or integrated into another system, or some features can be ignored or not implemented. On the other hand, the coupling, direct coupling or communication connection shown or discussed may be achieved through some interfaces, indirect coupling or communication connection between devices or units may electrical or otherwise.

The modules described as separate parts may be or may not be physically separated, and the assembly units that serve as display modules may or may not be physical units, that is, they may be located in one place, or they may be distributed over multiple network units.

In addition, each functional module in each embodiment of the disclosure may be integrated into a processing unit, or each unit can also physically exist separately, or two or more units can also be integrated into a unit. The integrated unit mentioned above can be realized either in the form of hardware or in the form of hardware and software functional modules.

The integrated units may be stored in a computer readable memory if implemented as a software program module and sold or used as a separate product. Based on this understanding, in nature, the technical solutions of the application or the part that contributes to the existing technology, or all or part of the technical solution can be manifested in the form of software products, the computer software products stored in a memory, including several instructions to make a computer equipment (such as a personal computer, a server or a network equipment, etc.) to perform all or part of the steps of the method described in each embodiment of this application.

The aforementioned memory includes: a USB flash drive, a ROM (Read-Only Memory), a RAM (Random Access Memory), a mobile hard disk drive, a diskette or a CD-ROM or other storage medium that can store program codes.

A person having ordinary skills in the field can understand that all or part of steps in various method described in the embodiments of this application can be executed by corresponding hardware commanded by the programs. The programs can be stored in a computer readable storage, and the computer readable storage can include: a flash drive, a Read-Only Memory (ROM), a Random Access Memory (RAM), a disk or a compact disk (CD), etc.

Although the disclosure is described in combination with specific features and embodiments, it is evident that it can be modified and combined in various ways without departing from the spirit and scope of the disclosure. Accordingly, this specification and accompanying drawings are only descriptions of the disclosure as defined by the claims and are deemed to cover any and all modifications, variations, combinations or equivalents within the scope of the disclosure. The foregoing descriptions are merely embodiments of the present disclosure, but not intended to limit the protection scope of the present disclosure. Any variation or replacement made by persons of ordinary skills in the art without departing from the spirit of the present disclosure shall fall within the protection scope of the present disclosure. Therefore, the scope of the present disclosure shall be subject to be appended claims.

1. A calculation method for a sparse neural network, comprising:
receiving a calculation instruction of a sparse neural network, and obtaining a weight CO*CI*n*m corresponding to the calculation instruction, according to the calculation instruction;
determining a kernel size KERNEL SIZE of the weight, and scanning the weight with the kernel size as a basic granularity to obtain a weight identifier, wherein, the weight identifier comprises: CO*CI values, if all weights in a k-th basic granularity KERNELₖ are 0, a weight identifier [K] corresponding the k-th basic granularity KERNELₖ in a corresponding position of the weight identifier is marked as a first feature value; if weights in the k-th basic granularity KERNELₖ are not all 0, the weight identifier [K] corresponding the k-th basic granularity KERNELₖ in a corresponding position of the weight identifier is marked as a second feature value; wherein, a range of k is [1, CO*CI];
storing KERNEL[n] [m] corresponding to the second feature value of the weight identifier, and deleting KERNEL[n] [m] corresponding to the first feature value of the weight identifier;
scanning all values of the weight identifier, extracting KERNEL corresponding to the values of the weight identifier and input data corresponding to the KERNEL and performing computation of the input data and the KERNEL to obtain an initial result when the values of the weight identifier are equal to the second feature value, and not reading the input data and the KERNEL corresponding to the values of the weight identifier when the values of the weight identifier are equal to the first feature value;
performing computation of all the initial results to obtain a calculation result of the calculation instruction.

2. The calculation method of claim 1, wherein, the n and m are integers greater than or equal to 1.

3. The calculation method of claim 1, the step of storing KERNEL[n] [m] corresponding to the second feature value of the weight identifier, comprising:
scanning a kernel identifier;
obtaining a value corresponding to a position of the kernel identifier; and
storing a KERNEL value corresponding to the position where the weight identifier is equal to 1 and the kernel identifier is equal to 1.

4. The calculation method of claim 2, wherein, when n=3 and m=3, the step of performing computation of the input data and the KERNEL to obtain an initial result, comprises:
scanning all values of a kernel identifier corresponding to KERNEL[3] [3], wherein the kernel identifier comprises 9 bits corresponding to 9 elements of the KERNEL[3] [3];
if a value of a position x2 of the kernel identifier is equal to 0, not reading an element value of the KERNEL[3] [3] corresponding to the position x2;
if a value of a position x1 of the kernel identifier is equal to 1, determining the position x1 corresponding to the value, and reading an element value KERNEL[3] [3]ₓ1; corresponding to the position x1 of the KERNEL [3] [3] and input data x1 corresponding to the position x1;
performing a product operation of the element value KERNEL[3] [3]ₓ1 and the input data x1 to obtain a product result; wherein, a value range of x1 is [1, 9]; and
obtaining the initial result by summing up all the product results with a value of the kernel identifier equal to 1.

5. A calculation device for a sparse neural network, comprising:
a transceiver interface, configured to receive a calculation instruction of a sparse neural network;
an obtaining circuit, configured to obtain a weight CO*CI*n*m corresponding to the calculation instruction from a memory, according to the calculation instruction;
a compiling circuit, configured to determine a kernel size KERNEL SIZE of the weight and scan the weight with the kernel size KERNEL SIZE as a basic granularity to obtain a weight identifier; wherein, the weight identifier comprises: CO*CI values, if all weights in a k-th basic granularity KERNEL_{K} are 0, a weight identifier [K] corresponding the k-th basic granularity KERNEL_{K} in a corresponding position of the weight identifier is marked as a first feature value; if weights in the k-th basic granularity KERNEL_{K} are not all 0, the weight identifier [K] corresponding the k-th basic granularity KERNEL_{K} in a corresponding position of the weight identifier is marked as a second feature value; wherein, a range of k is [1, CO*CI]; the compiling circuit, further configured to store KERNEL [n] [m] corresponding to a second feature value of the weight identifier and delete KERNEL [n] [m] corresponding to a first feature value of the weight identifier;
a calculation circuit, configured to scan all values of the weight identifier, extract KERNEL corresponding to the values of the weight identifier and input data corresponding to the KERNEL and perform computation of the input data and the KERNEL to obtain an initial result when the values of the weight identifier are equal to the second feature value, and not reading the KERNEL corresponding to the values and the input data corresponding to the KERNEL when the values of the weight identifier are equal to the first feature value; the calculation circuit, further configured to perform computation of all the initial results to obtain a calculation result of the calculation instruction.

6. The calculation device of claim 5, wherein, the n and m are integers greater than or equal to 1.

7. The calculation device of claim 5, wherein,
the first feature value is 0, and the second feature value is 1; or,
the first feature value is 1, and the second feature value is 0.

8. The calculation device of claim 6, wherein, when n=3 and m=3,
the calculation circuit is specifically configured to scan all values of a kernel identifier corresponding to KERNEL [3] [3], wherein the kernel identifier comprises 9 bits corresponding to 9 elements of the KERNEL [3] [3];
the calculation circuit is configured to, if a value of a position x2 of the kernel identifier is equal to 0, not read an element value of the KERNEL [3] [3] corresponding to the position x2;
the calculation circuit is configured to, if a value of a position x1 of the kernel identifier is equal to 1, determine the position x1 corresponding to the value, and read an element value KERNEL[3] [3]ₓ₁ corresponding to the position x1 of the KERNEL [3] [3] and input data x1 corresponding to the position x1;
the calculation circuit is further configured to perform a product operation of the element value KERNEL[3] [3]ₓ₁ and the input data x1 to obtain a product result; wherein, a value range of x1 is [1, 9]; and
the calculation circuit is further configured to obtain the initial result by summing up all the product results with a value of the kernel identifier equal to 1.

9. An electronic device, comprising a calculation device for a sparse neural network, wherein, the calculation method, comprises:
receiving a calculation instruction of a sparse neural network, and obtaining a weight CO*CI*n*m corresponding to the calculation instruction, according to the calculation instruction;
determining a kernel size KERNEL SIZE of the weight, and scanning the weight with the kernel size as a basic granularity to obtain a weight identifier, wherein, the weight identifier comprises: CO*CI values, if all weights in a k-th basic granularity KERNELₖ are 0, a weight identifier [K] corresponding the k-th basic granularity KERNELₖ in a corresponding position of the weight identifier is marked as a first feature value; if weights in the k-th basic granularity KERNELₖ are not all 0, the weight identifier [K] corresponding the k-th basic granularity KERNELₖ in a corresponding position of the weight identifier is marked as a second feature value; wherein, a range of k is [1, CO*CI];
storing KERNEL[n] [m] corresponding to the second feature value of the weight identifier, and deleting KERNEL[n] [m] corresponding to the first feature value of the weight identifier;
scanning all values of the weight identifier, extracting KERNEL corresponding to the values of the weight identifier and input data corresponding to the KERNEL and performing computation of the input data and the KERNEL to obtain an initial result when the values of the weight identifier are equal to the second feature value, and not reading the input data and the KERNEL corresponding to the values of the weight identifier when the values of the weight identifier are equal to the first feature value;
performing computation of all the initial results to obtain a calculation result of the calculation instruction.

10. (canceled)

11. (canceled)
